(19) United States
(12) Patent Application Publication
(10) Pub. No.: US 2023/0150531 A1
(43) Pub. Date: May 18, 2023

(54) APPARATUS FOR DETERMINING TRANSFER OF CONTROL AUTHORITY OF VEHICLE AND METHOD THEREOF

(71) Applicants: HYUNDAI MOTOR COMPANY, Seoul (KR); Kia Corporation, Seoul (KR)

(72) Inventors: Seo Hyeon PARK, Suwon-si (KR); Sung Yeon KO, Hanam-si (KR); Young Min HAN, Gunpo-si (KR); Jae Hwan JANG, Ulsan (KR)

(73) Assignees: HYUNDAI MOTOR COMPANY, Seoul (KR); Kia Corporation, Seoul (KR)

(21) Appl. No.: 17/743,748

(22) Filed: May 13, 2022

(30) Foreign Application Priority Data
Nov. 15, 2021 (KR) 10-2021-0156935

(51) Int. Cl. B60W 60/00; B60W 30/12; B60W 30/18

(52) U.S. Cl. CPC B60W 60/001; B60W 30/12; B60W 30/18036; B60W 2552/53; B60W 2420/52; B60W 2420/42

(57) ABSTRACT

The present disclosure relates to an apparatus and method for determining transfer of control authority of a vehicle for determining whether transfer of control right of a vehicle is required according to whether a reverse-driving vehicle exists in a driving lane. According to the present disclosure, an apparatus for determining transfer of control authority of a vehicle may obtain information on the vehicle's surroundings, and determine whether a reverse-driving vehicle exists in front of the host vehicle on the driving lane during autonomous driving of the vehicle, based on the information on the surroundings of the vehicle and high definition map information and determine a situation in which the transfer of control authority to the user is required based on whether or not a reverse-driving vehicle exists in front of the host vehicle on the driving lane.

### CROSS-REFERENCE TO RELATED APPLICATION

This application claims the benefit of priority to Korean Patent Application No. 10-2021-0156935, filed on Nov. 15, 2021 in the Korean Intellectual Property Office, the entire contents of which are incorporated herein by reference.

### TECHNICAL FIELD

The present disclosure relates to an apparatus and method for determining transfer of control authority of a vehicle, and more particularly, to an apparatus and method for determining whether transfer of control authority of a vehicle is required depending on whether a reverse-driving vehicle exists in a driving lane.

### BACKGROUND

An autonomous vehicle capable of reducing driver fatigue by performing driving, braking, and steering on behalf of a driver requires capability to adaptively respond to changing surroundings in real time while driving. For mass-production and boosting of autonomous vehicles, a reliable judgment and control function is required above all else. In recent vehicles, an ADAS (Automated Driving Assist System) function, a driver automatic driving assistance function, DSW (Driver Status Warning) function that determines driver negligence and state abnormalities such as drowsy driving and eye deviation and outputs a warning alarm via a cluster, or the like, a DAW (Driver Awareness Warning) function that determines whether a vehicle is driving unstable while crossing lanes via a front camera, an FCA (Forward Collision-Avoidance Assist) or AEBS (Active Emergency Brake System) function that performs sudden braking when a forward collision is detected.

When a situation occurs in which the vehicle is out of the operational design area while these functions are in operation, control authority of the vehicle may need to be transferred from a vehicle system to a user for safety reasons. In particular, when a reverse-driving vehicle (e.g., a vehicle driving in a reverse direction) exists in front of the vehicle on a driving lane, errors may occur in functions such as ADAS and driver's automatic driving assistance, which may lead to a serious accident.

The information disclosed in the Background section above is to aid in the understanding of the background of the present disclosure, and should not be taken as acknowledgement that this information forms any part of prior art.

### SUMMARY

The present disclosure has been made to solve the above-mentioned problems occurring in the prior art while advantages achieved by the prior art are maintained intact.

An aspect of the present disclosure provides an apparatus and method for determining whether transfer of control authority of a vehicle is required depending on whether a reverse-driving vehicle exists in a driving lane.

Another aspect of the present disclosure provides an apparatus and method for determining transfer of control authority of a vehicle which implement a strategy for responding to deviations from the operational design area of a driving assistance function such as an ADAS (Automated Driving Assist System) function.

Still another aspect of the present disclosure provides an apparatus and method for determining transfer of control authority of a vehicle which request transfer of control authority to a driver to prevent a major accident with the driver's response when there is a reverse-driving vehicle in the driving lane.

Still another aspect of the present disclosure provides an apparatus and method for determining transfer of control authority of a vehicle which determine whether a reverse-driving vehicle exists in the same lane as the host vehicle among reverse-driving vehicles, and output a request for transfer of control authority only when necessary.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for determining transfer of control authority of a host vehicle includes a sensor device provided in the host vehicle to obtain information on surroundings of the host vehicle, a storage that stores high definition map information on the surroundings of the host vehicle, and a controller that determines whether a reverse-driving vehicle exists in front of the host vehicle on a driving lane of the host vehicle during autonomous driving of the host vehicle, based on the information on the surroundings of the host vehicle and the high definition map information, and determines a situation in which the transfer of control authority to a user is required, based on whether the reverse-driving vehicle exists in front of the host vehicle on the driving lane.

The sensor device may include at least one of a camera, a radar, or a LIDAR (light detection and ranging).

The controller may detect a nearby vehicle around the host vehicle, determine whether the nearby vehicle is driving in a reverse direction in a lane in which the nearby vehicle is driving, and determine whether the reverse-driving vehicle exists in front of the driving lane of the host vehicle based on whether the lane in which the nearby vehicle determined as driving in the reverse direction is driving coincides with the driving lane of the host vehicle.

The controller may determine whether the nearby vehicle is driving in the reverse direction on the lane in which the nearby vehicle is driving based on an absolute speed of the nearby vehicle.

The controller may calculate the absolute speed of the nearby vehicle based on an absolute speed of the host vehicle and a relative speed of the nearby vehicle with respect to the host vehicle.

The controller may calculate a location of the host vehicle on an SN coordinate system with axes in the longitudinal (S-axis) and lateral (N-axis) directions of a road based on the high definition map information and a precise positioning result value therefrom, and determine the driving lane of the host vehicle based on the location of the host vehicle.

The controller may correct the location of the host vehicle based on a positional relationship associated with at least one of a nearby object, a nearby vehicle, or a nearby line of the host vehicle.

The controller may calculate an absolute location of the nearby vehicle determined as driving in the reverse direction based on the relative location of the nearby vehicle determined as driving in the reverse direction to the location of the host vehicle determined, using the location of the host vehicle and the information on surroundings.

The controller may calculate an N-axis distance to the nearby vehicle determined as driving in the reverse direction with respect to a center line of the driving lane of the host vehicle on the SN coordinate system based on the absolute location of the nearby vehicle determined as driving in the reverse direction, and determine a lane in which the nearby vehicle determined as driving in the reverse direction is driving, based on the N-axis distance to the nearby vehicle determined as driving in the reverse direction.

The controller may determine a driving lane of the nearby vehicle determined as driving in the reverse direction, in consideration of at least one of a width of the lane in which the nearby vehicle is driving or a width of the nearby vehicle determined as driving in the reverse direction.

The apparatus may further include an output device provided in the host vehicle to output a request for the transfer of control authority when the controller determines that the transfer of control authority to the user is required.

An aspect of the present disclosure, a method for determining transfer of control authority of a vehicle includes obtaining, by a sensor device provided in the vehicle, information on a host vehicle's surrounding, determining, by a controller, whether a reverse-driving vehicle exists in front of the host vehicle on a driving lane during autonomous driving of the host vehicle based on the information on the surroundings of the host vehicle and high definition map information on the surroundings of the host vehicle, and determining, by the controller, a situation in which the transfer of control authority to a user is required based on whether the reverse-driving vehicle exists in front of the host vehicle on the driving lane.

The determining, by the controller, of whether the reverse-driving vehicle exists in front of the host vehicle on the driving lane during the autonomous driving of the host vehicle may include detecting, by the controller, a nearby vehicle, determining, by the controller, whether the nearby vehicle is driving in a reverse direction on the driving lane, and determining, by the controller, whether the reverse-driving vehicle exists in front of the host vehicle on the driving lane of the vehicle based on whether the lane in which the nearby vehicle determined as driving in the reverse direction coincides with the driving lane of the host vehicle.

The determining, by the controller, of whether the nearby vehicle is driving in the reverse direction on the driving lane may include determining, by the controller, whether the nearby vehicle is driving in the reverse direction on the driving lane based on an absolute speed of the nearby vehicle.

The determining, by the controller, of whether the nearby vehicle is driving in the reverse direction on the driving lane may include calculating the absolute speed of the nearby vehicle based on an absolute speed of the host vehicle and a relative speed of the nearby vehicle with respect to the host vehicle.

The determining, by the controller, of whether the reverse-driving vehicle exists in front of the host vehicle on the driving lane of the vehicle based on whether the lane in which the nearby vehicle determined as driving in the reverse direction coincides with the driving lane of the host vehicle may include calculating, by the controller, a location of the host vehicle on an SN coordinate system based on longitudinal (S-axis) and lateral (N-axis) directions of a road, based on high definition map information and a precise positioning result value therefrom, and determining, by the controller, the driving lane of the host vehicle based on the location of the host vehicle.

The determining by the controller of whether the reverse-driving vehicle exists in front of the host vehicle on the driving lane of the vehicle based on whether the lane in which the nearby vehicle determined as driving in the reverse direction coincides with the driving lane of the host vehicle may include calculating an absolute location of the nearby vehicle determined as driving in the reverse direction based on a relative location of the nearby vehicle determined as driving in the reverse direction to the location of the host vehicle determined, using the location of the host vehicle and the information on surroundings.

The determining, by the controller, of whether the reverse-driving vehicle exists in front of the host vehicle on the driving lane of the vehicle based on whether the lane in which the nearby vehicle determined as driving in the reverse direction coincides with the driving lane of the host vehicle may include calculating, by the controller, an N-axis distance to the nearby vehicle determined as driving in the reverse direction with respect to a center line of the driving lane of the host vehicle on the SN coordinate system based on the absolute location of the nearby vehicle determined as driving in the reverse direction, and determining, by the controller, a lane in which the nearby vehicle determined as driving in the reverse direction is driving, based on the N-axis distance to the nearby vehicle determined as driving in the reverse direction.

The determining by the controller of whether the reverse-driving vehicle exists in front of the host vehicle on the driving lane of the vehicle based on whether the lane in which the nearby vehicle determined as driving in the reverse direction coincides with the driving lane of the host vehicle may include determining, by the controller, a driving lane of the nearby vehicle determined as driving in the reverse direction in consideration of at least one of a width of the lane in which the nearby vehicle is driving or a width of the nearby vehicle determined as driving in the reverse direction.

The method may further include outputting, by an output device, a request for transfer of control authority when determines that the transfer of control authority to the user is required, the output device being provided in the host vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an apparatus for determining transfer of control authority of a vehicle according to an embodiment of the present disclosure;

FIG. 2 is a diagram illustrating operation of an apparatus for determining transfer of control authority of a vehicle according to an embodiment of the present disclosure.

FIG. 3 is a diagram illustrating an example in which an apparatus for determining transfer of control authority of a vehicle determines a situation in which transfer of control authority of a vehicle is required according to an embodiment of the present disclosure;

FIGS. 4A, 4B, 4C and 4D are diagrams illustrating a case where an apparatus for determining transfer of control authority of a vehicle according to an embodiment of the present disclosure determines whether a reverse-driving vehicle exists in a driving lane on a straight road and performs or does not perform generation of a TD;

FIGS. 5A, 5B, 5C and 5D are diagrams illustrating a case where an apparatus for determining transfer of control authority of a vehicle according to an embodiment of the present disclosure determines whether a reverse-driving vehicle exists in a driving lane on a curved road and performs or does not perform generation of a TD; and

FIG. 6 is a flowchart illustrating a method for determining transfer of control authority of a vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all tams used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

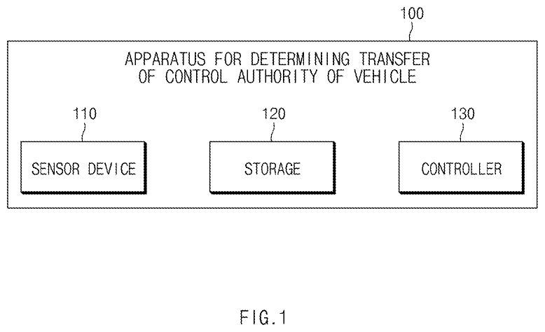

Hereinafter, embodiments of the present disclosure will be described in detail with reference to FIGS. 1 to 6.

FIG. 1 is a block diagram showing an apparatus for determining transfer of control authority of a vehicle according to an embodiment of the present disclosure.

An apparatus 100 for determining transfer of control authority of a vehicle according to the present disclosure may be implemented inside or outside the vehicle. In this case, the apparatus 100 for determining transfer of control authority of a vehicle may be integrally formed with the internal control units of the vehicle, or may be implemented as a separate hardware device and connected to the control units of the vehicle via connection means.

As an example, the apparatus 100 for determining transfer of control authority of a vehicle may be implemented integrally with a vehicle, may be implemented to be installed/attached to a vehicle as a configuration separate from the vehicle, or some components thereof may be implemented integrally with a vehicle and the other components may be implemented to be installed/attached to the vehicle as a configuration separate from the vehicle.

Referring to FIG. 1, the apparatus 100 for determining transfer of control authority of a vehicle may include a sensor device 110, storage 120, and a controller 130.

The sensor device 110 may be provided in the vehicle to obtain information about the vehicle's surroundings.

For example, the sensor device 110 may include at least one of a camera, a radar, or a LIDAR (light detection and ranging).

For example, the sensor device 110 may be implemented as an Advanced Driver Assistance System (ADAS) sensor.

For example, the sensor device 110 may include a sensor fusion module that fuses sensing information obtained via two or more types of sensors and outputs information on nearby lanes, information on nearby objects, and/or information on nearby vehicles.

For example, the sensor device 110 may be connected to the storage 120, and information obtained via the sensor device 110 may be stored in the storage 120.

Also, the sensor device 110 may be directly or indirectly connected to the controller 130 via wired or wireless communication, and transmit the obtained information to the controller 130.

The storage 120 may store high definition map (HD map) information on the surroundings of the vehicle.

As an example, the storage 120 may include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), an EEPROM (Electrically Erasable PROM), a MRAM (Magnetic RAM), a magnetic disk, and an optical disk type memory.

For example, the storage 120 may store data and/or algorithms required for the sensor device 110 and/or the controller 130 to operate.

For example, the high definition map information stored in the storage 120 may be automatically updated via a server at predetermined intervals or may be manually updated by a user.

The controller 130 may perform overall control such that each of the components normally performs its function. The controller 130 may be implemented in the form of hardware or software, or may be implemented in a combination of hardware and software. Preferably, the controller 130 may be implemented with a microprocessor, but is not limited thereto. In addition, the controller 130 may perform various data processing and computations, which will be described later.

The controller 130 may determine whether a reverse-driving vehicle exists in front of the host vehicle on the vehicle's driving lane during autonomous driving of the vehicle, based on the information on the surroundings of the vehicle and the high definition map information.

Ultimately, autonomous driving aims to enable the most advanced technology in the capability of operating a vehicle without the active control or monitoring of a driver for autonomous vehicles capable of driving, steering, and parking without human intervention.

However, the concept of autonomous driving that is currently being released may include technology in an intermediate stage of automation that leads to fully autonomous driving, and corresponds to a goal-oriented concept premised on the mass production and commercialization of fully autonomous vehicles.

For example, autonomous driving technology may include ADAS technologies such as Highway Driving Pilot (HDP), Highway Driving Assist (HDA), Lane Keeping Assist (LKA), Lane Following Assist (LFA), and Lane Departure Warning (LDW) or driver autonomous driving assistance technologies.

As an example, the controller 130 may determine whether a reverse-driving vehicle exists in front of the host vehicle on the driving lane in a state in which a function corresponding to driving assistance levels 2 or 3 by the National Highway Traffic Safety Administration (NHTSA), such as an ADAS or driver automatic driving assistance function, or a function corresponding to autonomous driving levels 2, 3 or 4 by the Society of Automotive Technology (SAE) is activated.

Reverse driving may mean that a vehicle is driving in a direction opposite to a driving direction suitable for a road condition in which vehicles are driving.

The controller 130 may detect a nearby vehicle around a host vehicle and determine whether the nearby vehicle is driving in a reverse direction in a lane in which the nearby vehicle is driving.

As an example, the controller 130 may determine whether the nearby vehicle is driving in the reverse direction on the lane in which the nearby vehicle is driving, based on the absolute speed of the nearby vehicle.

As an example, the controller 130 may calculate the absolute speed of the nearby vehicle based on the absolute speed of the host vehicle and the relative speed of the nearby vehicle to the host vehicle.

For example, the controller 130 may calculate the absolute speed of the nearby vehicle by obtaining a vector sum of the absolute speed of the host vehicle and the relative speed of the nearby vehicle to the host vehicle.

For example, the controller 130 may determine the absolute speed of the host vehicle via dynamics information of the host vehicle.

As an example, the controller 130 may determine the relative speed of the nearby vehicle to the host vehicle based on sensor information obtained via the sensor device 110.

As an example, the controller 130 may determine the relative speed of the nearby vehicle based on a change in the relative location of the nearby vehicle determined via the sensor information obtained via the sensor device 110.

The absolute speed of the nearby vehicle is a vector value including the speed and the direction, and whether the nearby vehicle is driving in the reverse direction may be determined via the absolute speed and the forward direction of the driving lane of the nearby vehicle.

For example, the controller 130 may determine the forward direction of a lane in which a nearby vehicle is driving based on the high definition map information and/or navigation information.

The controller 130 may determine whether a reverse-driving vehicle exists in front of the host vehicle on the driving lane of the host vehicle based on whether the lane in which a nearby vehicle determined as driving in the reverse direction is driving coincides with the driving lane of the host vehicle.

Even though there is a nearby vehicle which is driving in the reverse direction around the host vehicle, when a road on which the nearby vehicle is driving is different from a road on which the host vehicle is driving, there may be little or no risk of collision between the two vehicles. Therefore, it may be necessary to determine whether the road on which the host vehicle is driving coincides with the road on which the reverse-driving vehicle is driving to determine a situation in which the transfer of control authority is required.

For example, the controller 130 may calculate a location of the host vehicle on an SN coordinate system with axes in the longitudinal (S-axis) and lateral (N-axis) directions of the road based on the high definition map information and a precise positioning result value therefrom, e.g., precise at a few centimeter level (but not limited thereto), and determine the driving lane of the host vehicle based on the location of the host vehicle.

Here, the SN coordinate system may be a coordinate system representing the coordinates of vehicles and objects on a straight or curved road based on the longitudinal axis (S-axis) which is the driving direction of the road and the lateral axis (N-axis) perpendicular to the driving direction.

In addition, precise positioning may refer to a location precisely measured in cm units for example. The precise positioning may be a location calculated based on location information via a global positioning system (GPS) and information obtained via a sensor of the vehicle.

As an example, the precise positioning may be a location in which the location of the host vehicle received via the GPS is corrected according to a positional relationship with at least one of a nearby object, a nearby vehicle, or a nearby line of the host vehicle.

As an example, the controller 130 may correct the location of the host vehicle based on the positional relationship with at least one of a nearby object, a nearby vehicle, or a nearby line of the host vehicle.

Specifically, the controller 130 may correct the location of the host vehicle based on a positional relationship with a guard rail, a median strip, or a nearby vehicle detected via the radar and/or the LIDAR or a positional relationship with a lane detected via a camera.

For example, the controller 130 may determine the absolute location of the host vehicle based on the absolute location of a nearby object determined via the high definition map information of the host vehicle and the relative location between the host vehicle and the nearby object, and correct the location of the host vehicle on the SN coordinate system based on the determined absolute location.

As another example, the controller 130 may determine the absolute location of the host vehicle based on the absolute location of a nearby vehicle determined via communication with a sever or the nearby vehicle and the relative location between the host vehicle and the nearby object, and correct the location of the host vehicle on the SN coordinate system based on the determined absolute location.

As another example, the controller 130 may determine the absolute location of the host vehicle based on the absolute location of a nearby lane determined via the high definition map information of the host vehicle and the relative location between the host vehicle and the nearby lane, and correct the location of the host vehicle on the SN coordinate system based on the determined absolute location.

The controller 130 may correct the location of the host vehicle on the SN coordinate system in consideration of the reliability of the absolute location of the host vehicle determined based on the positional relationship with at least one of the nearby object of the vehicle, the nearby vehicle, or the nearby lane.

For example, the controller 130 may correct the location of the host vehicle on the SN coordinate system via a weighted average obtained by considering the average of the absolute location of the host vehicle determined based on the positional relationship with at least one of the nearby object, the nearby vehicle, or the nearby lane of the host vehicle and the location of the host vehicle on the SN coordinate system or the reliability of the absolute location.

As an example, the controller 130 may calculate the absolute location of the nearby vehicle determined as driving in the reverse direction based on the relative location of the nearby vehicle determined as driving in the reverse direction to the location of the host vehicle determined via the location of the host vehicle and the information on surroundings.

For example, the controller 130 may determine the absolute location of the host vehicle based on the GPS location or precise positioning of the host vehicle.

As an example, the controller 130 may determine the relative location of the nearby vehicle determined as driving in the reverse direction with respect to the host vehicle based on the information obtained via the sensor device 110.

For example, the controller 130 may calculate the absolute location of the nearby vehicle by summing the absolute location of the host vehicle and the relative location of the nearby vehicle determined as driving in the reverse direction with respect to the host vehicle.

As an example, the controller 130 may calculate an N-axis distance to the nearby vehicle determined as driving in the reverse direction with respect to the center line of the driving lane of the host vehicle on the SN coordinate system based on the absolute location of the nearby vehicle determined as driving in the reverse direction and determine a lane in which the nearby vehicle determined as driving in the reverse direction is driving based on the distance in the N-axis to the nearby vehicle determined as driving in the reverse direction.

As an example, the controller 130 may calculate the shortest distance in the N-axis direction to the contour of the nearby vehicle as driving in the reverse direction based on the center line of the driving lane of the host vehicle on the SN coordinate system based on the high definition map information and the sensor information via the sensor device 110.

As an example, the controller 130 may determine the driving lane of the nearby vehicle determined as driving in the reverse direction by considering at least one of the width of the lane and the width of the nearby vehicle determined as driving in the reverse direction.

As an example, the controller 130 may determine that the nearby vehicle is driving in a relevant lane in the reverse direction when the sum of the shortest distance in the N-axis direction to the contour of the nearby vehicle determined as driving in the reverse direction with respect to the center line of the host vehicle's driving lane in the SN coordinate system and the half of the width of the nearby vehicle is greater than half of the width of the corresponding lane.

As an example, the controller 130 may determine that the nearby vehicle is not driving in a relevant lane in the reverse direction when the sum of the shortest distance in the N-axis direction to the contour of the nearby vehicle determined as driving in the reverse direction with respect to the center line of the host vehicle's driving lane in the SN coordinate system and the half of the width of the nearby vehicle is less than half of the width of the corresponding lane.

For example, when it is determined that the nearby vehicle is not driving in the corresponding lane in the reverse direction, the controller 130 may determine whether the nearby vehicle is driving in another lane in the same manner with respect to the other lane.

The controller 130 may determine a situation in which the transfer of control authority to the user is required based on whether a reverse-driving vehicle exists in front of the host vehicle on the driving lane of the host vehicle.

For example, when a reverse-driving vehicle exists in front of the host vehicle on the driving lane, the controller 130 may determine a situation in which the transfer of control authority to the user is required.

Although not shown, the apparatus 100 for determining transfer of control authority of a vehicle may further include an output device provided in a vehicle to output a request for transfer of control authority when it is determined via the controller that the transfer of control authority to the user is required.

A request for transfer of control authority may be referred to as a transition demand (TD).

As an example, the output device may transmit the request for transfer of control authority to the user by visually or audibly outputting a warning or message.

For example, the output device may be implemented via a cluster or AVN (Audio, Video, Navigation) provided in the vehicle, but is not limited thereto, and may be implemented via a device provided in the vehicle or communicatively connected to the vehicle to output a visual or audible signal.

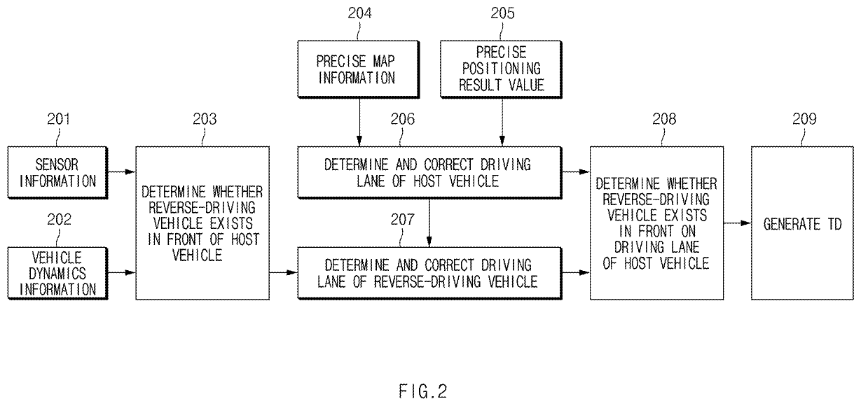

FIG. 2 is a diagram illustrating operation of an apparatus for determining transfer of control authority of a vehicle according to an embodiment of the present disclosure.

The apparatus 100 for determining transfer of control authority of the vehicle may determine whether a reverse-driving vehicle exists in front of the host vehicle based on sensor information 201 and vehicle dynamics information 202 (203).

For example, the apparatus 100 for determining transfer of control authority of the vehicle may determine an absolute speed of the host vehicle via the vehicle dynamics information 202.

As an example, the apparatus 100 for determining transfer of control authority of the vehicle may determine the relative speed of a nearby vehicle to the host vehicle via the sensor information 201.

As an example, the apparatus 100 for determining transfer of control authority of the vehicle may determine the absolute speed of the nearby vehicle based on the absolute speed of the host vehicle and the relative speed of the nearby vehicle.

As an example, the apparatus 100 for determining transfer of control authority of the vehicle may determine whether the nearby vehicle is a reverse-driving vehicle based on the absolute speed of the nearby vehicle and high definition map information.

The apparatus 100 for determining transfer of control authority of the vehicle may determine and correct a driving lane of the host vehicle based on high definition map information 204 and precise positioning result value(s) 205 (206).

As an example, the apparatus 100 for determining transfer of control authority of the vehicle may calculate and correct a location of the host vehicle via high definition map information 204, the sensor information 201, and the precise positioning result value 205.

As an example, the apparatus 100 for determining transfer of control authority of the vehicle may determine the host vehicle's driving lane based on the location of the host vehicle and the high definition map information 204.

The apparatus 100 for determining transfer of control authority of the vehicle may determine and correct the driving lane of the reverse-driving vehicle based on the high definition map information 204, the precise positioning result value 205, and the sensor information 201 (207).

As an example, the apparatus 100 for determining transfer of control authority of the vehicle may determine the absolute location of the reverse-driving vehicle based on the absolute location of the host vehicle and the relative location of the reverse-driving vehicle to the host vehicle determined via the sensor information 201.

As an example, the apparatus 100 for determining transfer of control authority of the vehicle may determine the reverse-driving vehicle's driving lane based on the absolute location of the reverse-driving vehicle and the high definition map information 204.

For example, the apparatus 100 for determining transfer of control authority of the vehicle may primarily determine, as the driving lane of the reverse-driving vehicle, a lane having the closest lateral distance from the center of the lane to the reverse-driving vehicle on the high definition map information 204.

For example, the apparatus 100 for determining transfer of control authority of a vehicle may correct the determined driving lane of the reverse-driving vehicle using accurate values of the width of the lane and the width of the reverse-driving vehicle.

Based on the result of determining and correcting the driving lane of the host vehicle (206) and the result of determining and correcting the driving lane of the reverse-driving vehicle (207), the apparatus 100 for determining transfer of control authority of a vehicle may determine whether a reverse-driving vehicle exists in the driving lane of the host vehicle (208).

For example, when the determined and corrected driving lane of the host vehicle coincides with the determined and corrected driving lane of the reverse-driving vehicle, the apparatus 100 for determining transfer of control authority of a vehicle may determine that the reverse-driving vehicle exists in the driving lane of the host vehicle.

When it is determined that the reverse-driving vehicle exists in the driving lane of the host vehicle as a result of determining whether the reverse-driving vehicle exists in the driving lane of the host vehicle (208), the apparatus 100 for determining transfer of control authority of a vehicle may generate a TD (209).

As an example, the apparatus 100 for determining transfer of control authority of a vehicle may output a visual and/or audible signal from the inside of the vehicle to generate a TD (209).

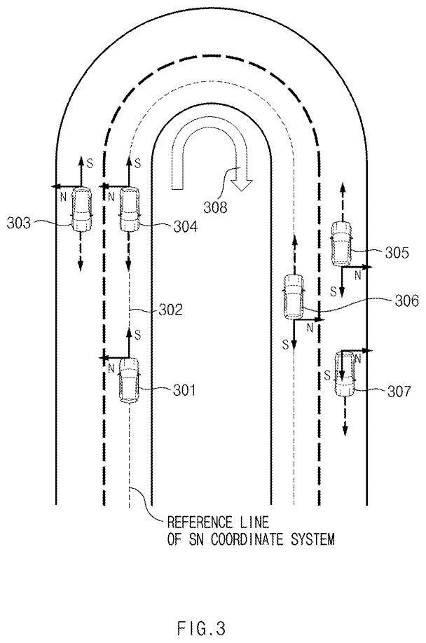

FIG. 3 is a diagram illustrating an example in which an apparatus for determining transfer of control authority of a vehicle determines a situation in which transfer of control authority of a vehicle is required according to an embodiment of the present disclosure.

Referring to FIG. 3, the apparatus 100 for determining transfer of control authority of a vehicle which is provided in a host vehicle 301 may determine whether the nearby vehicles 303 to 307 are reverse-driving vehicles.

As an example, the apparatus 100 for determining transfer of control authority of a vehicle may determine a reverse-driving vehicle among the nearby vehicles 303 to 307 using the absolute speeds of the nearby vehicles 303 to 307 calculated based on the absolute speed of the host vehicle 301 and the relative speeds of the nearby vehicles 303 to 307 to the host vehicle 301 and high definition map information.

For example, when the absolute speed of the nearby vehicles 303 to 307 is opposite to a driving direction 308 suitable for the road, the apparatus 100 for determining transfer of control authority of a vehicle may determine a corresponding nearby vehicle as a reverse-driving vehicle.

The apparatus 100 for determining transfer of control authority of a vehicle may determine nearby vehicles corresponding to reference numerals 303, 304, 305 and 306 having absolute speeds opposite to the driving direction 308 suitable for the road as the reverse-driving vehicles.

The apparatus 100 for determining transfer of control authority of a vehicle may determine a lane in which the reverse-driving vehicles corresponding to reference numerals 303 to 306 are driving.

For example, the apparatus 100 for determining transfer of control authority of a vehicle may set a virtual center line of a lane in which the host vehicle 301 is driving as a reference line 302 of the SN coordinate system.

As an example, the apparatus 100 for determining transfer of control authority of a vehicle may determine whether the reverse-driving vehicle is driving on the lane in which the host vehicle 301 is driving based on distances to the reverse-driving vehicles corresponding to reference numerals 303 to 306 with respect to the reference line 302 of the SN coordinate system.

For example, when the distance to the reverse driving vehicle is less than a threshold value with respect to the reference line 302 of the SN coordinate system, the apparatus 100 for determining transfer of control authority of a vehicle may determine that the reverse-driving vehicle is driving the lane in which the host vehicle 301 is driving.

As an example, the distance to the reverse-driving vehicle with respect to the reference line 302 of the SN coordinate system may be the shortest distance to the contour of the reverse-driving vehicle with respect to the reference line 302 of the SN coordinate system, and the threshold value may be a value obtained by subtracting the half of the width of the reverse-driving vehicle from the half of the lane in which the host vehicle 301 is driving, or a value obtained by applying a preset correction value to the value.

The apparatus 100 for determining transfer of control authority of a vehicle may determine that the reverse-driving vehicle corresponding to the reference numbers 304 and 306 among the reverse-driving vehicles corresponding to the reference numerals 304 and 306 are vehicles that are running in the reverse direction in front of the host vehicle on the driving lane of the host vehicle among the reverse-driving vehicles corresponding to the reference numerals 303 to 306.

The apparatus 100 for determining transfer of control authority of a vehicle may generate a TD and output a request for transfer of control authority because there are vehicles driving in the reverse direction corresponding to reference numerals 304 and 306 in front of the host vehicle on the driving lane of the host vehicle.

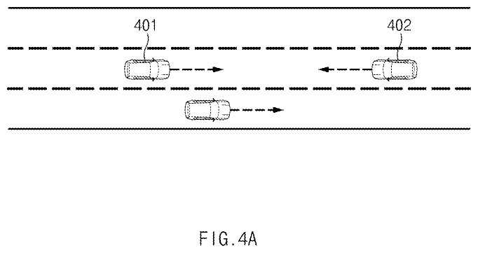

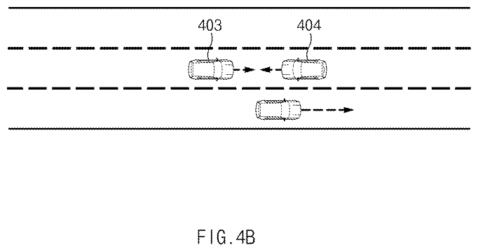

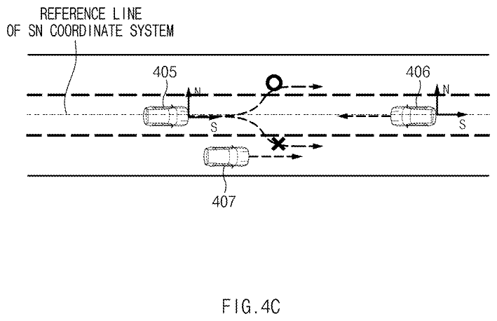

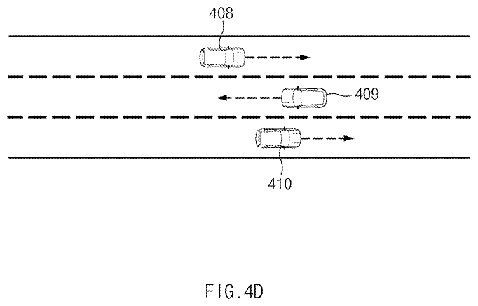

FIGS. 4A to 4D are diagrams illustrating a case where an apparatus for determining transfer of control authority of a vehicle according to an embodiment of the present disclosure determines whether a reverse-driving vehicle exists in a driving lane on a straight road and performs or does not perform generation of a TD.

FIGS. 4A and 4B are diagrams illustrating a case in which host vehicles 401 and 403 whether reverse-driving vehicles 402 and 404 exist in the driving lane and do not perform the generation of the TD.

During autonomous driving of the host vehicle 401, when there is another nearby vehicle 402 driving in a reverse direction in front of the host vehicle on the driving lane, an autonomous vehicle may determine that an operational design area for an autonomous driving function has deviated or that the nearby vehicle 402 driving in a reverse direction on the driving lane is a vehicle driving in the forward direction, and continue to drive on the lane in which the autonomous vehicle has been driving.

In this case, when the distance between the host vehicle 403 and the nearby vehicle 404 driving in the reverse direction is close to each other less than a specific threshold, rapid deceleration of the host vehicle 403 for maintaining the inter-vehicle distance may be performed by the autonomous driving function.

However, the lane change of the host vehicle 403 is not performed, and the nearby vehicle 404 driving in the reverse direction maintains the reverse driving state as it is, eventually leading to a collision accident between the host vehicle 403 and the nearby vehicle 404 driving in the reverse direction.

FIGS. 4C and 4D are diagrams illustrating a case in which the host vehicles 405 and 408 determine whether reverse-driving vehicles 406 and 409 exist in the driving lane and perform the generation of the TD.

When there is another nearby vehicle 406 driving in the reverse direction in front of the host vehicle on the driving lane during autonomous driving of the host vehicle 405, the apparatus 100 for determining transfer of control authority of a vehicle may detect the nearby vehicle 406 driving in the reverse direction in front of the host vehicle on the driving lane using sensor information, high definition map information, and a reference line of the SN coordinate system and generate a TD to transmit a request for transfer of control authority to a user.

In this case, the user may receive the control authority and directly control the host vehicle 405.

The user may attempt to change lanes into a left lane or a right lane to avoid the reverse-driving vehicle 406 in front.

The user may recognize that another nearby vehicle 407 exits in the right lane, determine that it is impossible to change the lane to the right lane, and may change the lane to the left lane.

As a result, the host vehicle 408 which has changed to the left lane may avoid the nearby vehicle 410 and the reverse-driving vehicle 409 in the right lane, leading to safe driving.

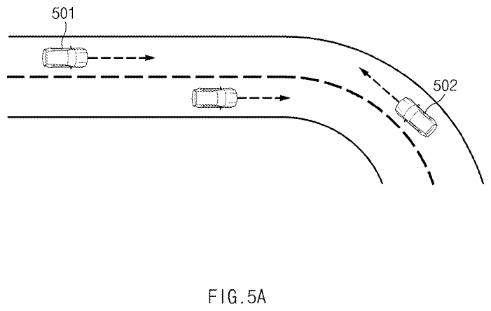

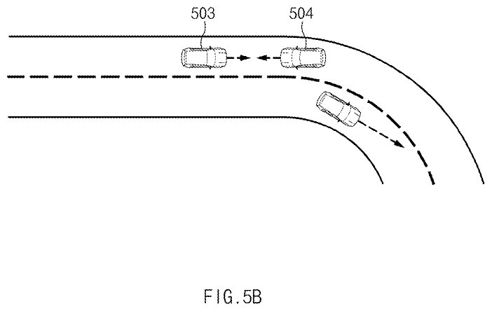

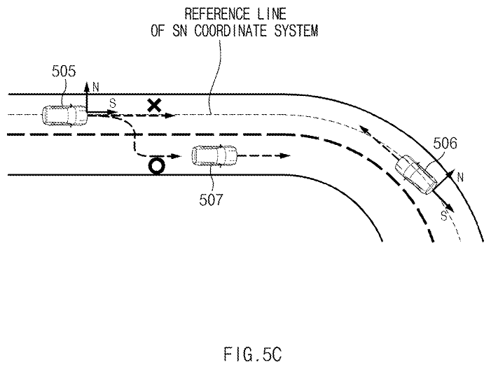

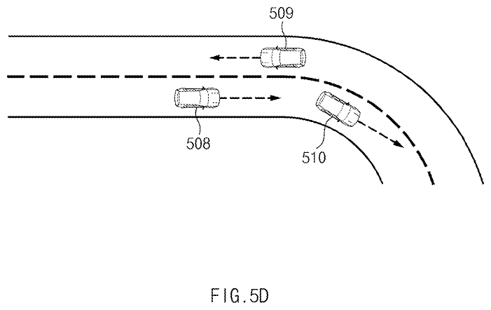

FIGS. 5A to 5D are diagrams illustrating a case where an apparatus for determining transfer of control authority of a vehicle according to an embodiment of the present disclosure determines whether a reverse-driving vehicle exists in a driving lane on a curved road and performs or does not perform generation of a TD.

FIGS. 5A and 5B are diagrams illustrating a case in which host vehicles 501 and 503 determine whether reverse-driving vehicles 502 and 504 exists in the driving lane and do not perform the generation of the TD.

During autonomous driving of the host vehicle 501, when there is another nearby vehicle 502 driving in a reverse direction in front of the host vehicle on the driving lane, an autonomous vehicle may determine that an operational design area for an autonomous driving function has deviated or that the nearby vehicle 502 driving in a reverse direction on the driving lane is a vehicle driving in the forward direction, and continue to drive on the lane in which the autonomous vehicle has been driving.

In this case, when the distance between the host vehicle 503 and the nearby vehicle 504 driving in the reverse direction is close to each other less than a specific threshold, rapid deceleration of the host vehicle 503 for maintaining the inter-vehicle distance may be performed by the autonomous driving function.

However, the lane change of the host vehicle 503 is not performed, and the nearby vehicle 504 driving in the reverse direction maintains the reverse driving state as it is, eventually leading to a collision accident between the host vehicle 503 and the nearby vehicle 504 driving in the reverse direction.

FIGS. 5C and 5D are diagrams illustrating a case in which host vehicles 505 and 508 determine whether reverse-driving vehicles 506 and 509 exists in the driving lane and perform the generation of the TD.

When there is another nearby vehicle 506 driving in the reverse direction in front of the host vehicle on the driving lane during autonomous driving of the host vehicle 505, the apparatus 100 for determining transfer of control authority of a vehicle may detect the nearby vehicle 506 driving in the reverse direction in front of the host vehicle on the driving lane using sensor information, high definition map information, and a reference line of the SN coordinate system and generate a TD to transmit a request for transfer of control authority to a user.

In this case, the user may receive the control authority and directly control the host vehicle 505.

The user may consider changing lanes to avoid the vehicle 506 driving in the reverse direction in front.

There is no lane to change on the left side of the user and another nearby vehicle 507 exists on the right lane, but the user may change the lane at the rear side of the nearby vehicle 507 on the right lane by slowing the speed.

As a result, the host vehicle 508 which has changed to the right lane may avoid the nearby vehicle 510 and the reverse-driving vehicle 509 in the right lane, leading to safe driving.

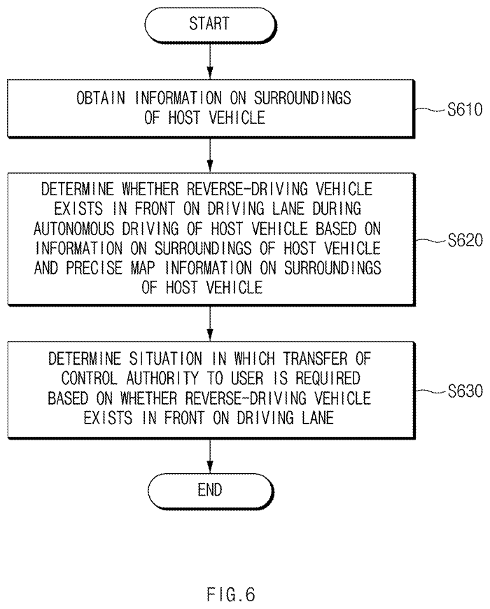

FIG. 6 is a flowchart illustrating a method for determining transfer of control authority of a vehicle according to an embodiment of the present disclosure.

Referring to FIG. 6, a method for determining transfer of control authority of a vehicle may include obtaining information on a host vehicle's surroundings (S610), determining whether a reverse-driving vehicle exists in front of the host vehicle on a driving lane during autonomous driving of the host vehicle based on the information on the surroundings of the host vehicle and high definition map information on the surroundings of the host vehicle (S620) and determining a situation in which the transfer of control authority to the user is required based on whether a reverse-driving vehicle exists in front of the host vehicle on a driving lane (S630).

In the method for determining transfer of control authority of a vehicle, the obtaining of the information on the surroundings of the host vehicle (S610) may be performed by the sensor device 110 provided in the host vehicle.

The determining whether the reverse-driving vehicle exists in front of the host vehicle on a driving lane during autonomous driving of the host vehicle based on the information on the surroundings of the host vehicle and high definition map information on the surroundings of the host vehicle (S620) may be performed by the controller 130.

For example, the high definition map information may be stored in the storage 120 provided in the host vehicle.

As an example, the determining by the controller 130 of whether the reverse-driving vehicle exists in front of the host vehicle on a driving lane during autonomous driving of the host vehicle (S620) may include detecting, by the controller 130, a nearby vehicle, determining, by the controller 130, whether the nearby vehicle is driving in a reverse direction on the driving lane, and determining, by the controller 130, whether a reverse-driving vehicle exists in front of the host vehicle on the driving lane of the vehicle based on the lane in which the nearby vehicle determined as driving in the reverse direction coincides with the driving lane of the host vehicle.

For example, the determining by the controller 130 of whether the nearby vehicle is driving in the reverse direction on the driving lane may include determining, by the controller 130, whether the nearby vehicle is driving in the reverse direction on the driving lane based on the absolute speed of the nearby vehicle.

For example, the determining by the controller 130 of whether the nearby vehicle is driving in the reverse direction on the driving lane may further include calculating the absolute speed of the nearby vehicle based on the absolute speed of the host vehicle and the relative speed of the nearby vehicle with respect to the host vehicle.

As an example, the determining by the controller 130 of whether a reverse-driving vehicle exists in front of the host vehicle on the driving lane of the vehicle based on the lane in which the nearby vehicle determined as driving in the reverse direction coincides with the driving lane of the host vehicle may include calculating, by the controller 130, a location of the host vehicle on an SN coordinate system based on longitudinal (S-axis) and lateral (N-axis) directions of a road, based on high definition map information and a precise positioning result value therefrom, and determining, by the controller 130, a driving lane of the host vehicle based on the location of the host vehicle.

As an example, the determining by the controller 130 of whether a reverse-driving vehicle exists in front of the host vehicle on the driving lane of the vehicle based on the lane in which the nearby vehicle determined as driving in the reverse direction coincides with the driving lane of the host vehicle may include calculating, by the controller 130, an absolute location of the nearby vehicle determined as driving in the reverse direction based on the location of the host vehicle and a relative location of the nearby vehicle determined as driving in the reverse direction with respect to the location of the host vehicle determined via the information on the surroundings.

As an example, the determining by the controller 130 of whether a reverse-driving vehicle exists in front of the host vehicle on the driving lane of the vehicle based on the lane in which the nearby vehicle determined as driving in the reverse direction coincides with the driving lane of the host vehicle may include calculating an N-axis distance to the nearby vehicle determined as driving in the reverse direction with respect to a center line of a driving lane of the host vehicle on the SN coordinate system based on the absolute location of the nearby vehicle determined as driving in the reverse direction and determining, by the controller 130, a lane in which the nearby vehicle determined as driving in the reverse direction is driving, based on the N-axis distance to the nearby vehicle determined as driving in the reverse direction.

As an example, the determining by the controller 130 of whether a reverse-driving vehicle exists in front of the host vehicle on the driving lane of the vehicle based on the lane in which the nearby vehicle determined as driving in the reverse direction coincides with the driving lane of the host vehicle may include determining, by the controller 130, a driving lane of the nearby vehicle determined as driving in the reverse direction in consideration of at least one of a width of the lane or a width of the nearby vehicle determined as driving in the reverse direction.

The determining of a situation in which the transfer of control authority to the user is required based on whether a reverse-driving vehicle exists in front of the host vehicle on the driving lane (S630) may be performed by the controller 130.

Although not shown, the method for determining transfer of control authority of a vehicle may further include outputting, by an output device, a request for transfer of control authority when it is determined via the controller 130 that the transfer of control authority to a user is required, the output device being provided in the host vehicle.

The operations of the method or the algorithm described in connection with the embodiments disclosed herein may be embodied directly in hardware or a software module executed by the processor, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The effects of the apparatus and method for determining transfer of control authority of a vehicle according to the present disclosure are given as follows.

According to at least one of the embodiments of the present disclosure, it is possible to provide an apparatus and method for determining whether transfer of control authority of a vehicle is required depending on whether a reverse-driving vehicle exists in a driving lane.

Further, according to at least one of the embodiments of the present disclosure, it is possible to provide an apparatus and method for determining transfer of control authority of a vehicle which implement a strategy for responding to deviations from the operational design area of a driving assistance function such as an ADAS (Automated Driving Assist System) function.

Further, according to at least one of the embodiments of the present disclosure, it is possible to provide an apparatus and method for determining transfer of control authority of a vehicle which request transfer of control authority to a driver to prevent a major accident with the driver's response when there is a reverse-driving vehicle in the driving lane.

Further, according to at least one of the embodiments of the present disclosure, it is possible to provide an apparatus and method for determining transfer of control authority of a vehicle which determine whether a reverse-driving vehicle exists in the same lane as the host vehicle among reverse-driving vehicles, and output a request for transfer of control authority only when necessary.

In addition, various effects may be provided that are directly or indirectly understood via the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for determining transfer of control authority of a host vehicle comprising:
a sensor device disposed in the host vehicle and configured to obtain information on surroundings of the host vehicle;
a storage configured to store high definition map information on the surroundings of the host vehicle; and
a controller configured to:
determine whether a reverse-driving vehicle exists in front of the host vehicle on a driving lane of the host vehicle during autonomous driving of the host vehicle, based on the information on the surroundings of the host vehicle and the high definition map information, and
determine a situation in which the transfer of control authority to a user is required, based on whether the reverse-driving vehicle exists in front of the host vehicle on the driving lane.

2. The apparatus of claim 1, wherein the sensor device includes at least one of a camera, a radar, or a LIDAR (light detection and ranging).

3. The apparatus of claim 1, wherein the controller is further configured to:
detect a nearby vehicle around the host vehicle,
determine whether the nearby vehicle is driving in a reverse direction in a lane in which the nearby vehicle is driving, and
determine whether the reverse-driving vehicle exists in front of the host vehicle on the driving lane based on whether the lane in which the nearby vehicle determined as driving in the reverse direction is driving coincides with the driving lane of the host vehicle.

4. The apparatus of claim 3, wherein the controller is further configured to determine whether the nearby vehicle is driving in the reverse direction on the lane in which the nearby vehicle is driving based on an absolute speed of the nearby vehicle.

5. The apparatus of claim 4, wherein the controller is further configured to calculate the absolute speed of the nearby vehicle based on an absolute speed of the host vehicle and a relative speed of the nearby vehicle with respect to the host vehicle.

6. The apparatus of claim 3, wherein the controller is further configured to:
calculate a location of the host vehicle on an SN coordinate system with axes in longitudinal (S-axis) and lateral (N-axis) directions of a road based on the high definition map information and a positioning result value therefrom, and
determine the driving lane of the host vehicle based on the location of the host vehicle.

7. The apparatus of claim 6, wherein the controller is further configured to correct the location of the host vehicle based on a positional relationship associated with at least one of a nearby object, a nearby vehicle, or a nearby line of the host vehicle.

8. The apparatus of claim 6, wherein the controller is further configured to calculate an absolute location of the nearby vehicle determined as driving in the reverse direction based on a relative location of the nearby vehicle determined as driving in the reverse direction to the location of the host vehicle determined, using the location of the host vehicle and the information on the surroundings.

9. The apparatus of claim 8, wherein the controller is further configured to:
calculate an N-axis distance to the nearby vehicle determined as driving in the reverse direction with respect to a center line of the driving lane of the host vehicle on the SN coordinate system based on the absolute location of the nearby vehicle determined as driving in the reverse direction, and
determine a lane in which the nearby vehicle determined as driving in the reverse direction is driving, based on the N-axis distance to the nearby vehicle determined as driving in the reverse direction.

10. The apparatus of claim 8, wherein the controller is further configured to determine a driving lane of the nearby vehicle determined as driving in the reverse direction, in consideration of at least one of a width of the lane in which the nearby vehicle is driving or a width of the nearby vehicle determined as driving in the reverse direction.

11. The apparatus of claim 1, further comprising:
an output device disposed in the host vehicle and configured to output a request for the transfer of control authority when the controller determines that the transfer of control authority to the user is required.

12. A method for determining transfer of control authority of a host vehicle comprising:
obtaining, by a sensor device disposed in the host vehicle, information on surroundings of the host vehicle;
determining, by a controller, whether a reverse-driving vehicle exists in front of the host vehicle on a driving lane of the host vehicle during autonomous driving of the host vehicle based on the information on the surroundings of the host vehicle and high definition map information on the surroundings of the host vehicle; and
determining, by the controller, a situation in which the transfer of control authority to a user is required based on whether the reverse-driving vehicle exists in front of the host vehicle on the driving lane.

13. The method of claim 12, wherein the determining, by the controller, of whether the reverse-driving vehicle exists in front of the host vehicle on the driving lane during the autonomous driving of the host vehicle includes:
detecting, by the controller, a nearby vehicle,
determining, by the controller, whether the nearby vehicle is driving in a reverse direction on the driving lane, and
determining, by the controller, whether the reverse-driving vehicle exists in front of the host vehicle on the driving lane of the host vehicle based on whether the lane in which the nearby vehicle determined as driving in the reverse direction coincides with the driving lane of the host vehicle.

14. The method of claim 13, wherein the determining, by the controller, of whether the nearby vehicle is driving in the reverse direction on the driving lane includes determining, by the controller, whether the nearby vehicle is driving in the reverse direction on the driving lane based on an absolute speed of the nearby vehicle.

15. The method of claim 14, wherein the determining, by the controller, of whether the nearby vehicle is driving in the reverse direction on the driving lane includes calculating the absolute speed of the nearby vehicle based on an absolute speed of the host vehicle and a relative speed of the nearby vehicle with respect to the host vehicle.

16. The method of claim 13, wherein the determining, by the controller, of whether the reverse-driving vehicle exists in front of the host vehicle on the driving lane of the host vehicle based on whether the lane in which the nearby vehicle determined as driving in the reverse direction coincides with the driving lane of the host vehicle includes:
calculating, by the controller, a location of the host vehicle on an SN coordinate system based on longitudinal (S-axis) and lateral (N-axis) directions of a road, based on high definition map information and a positioning result value therefrom, and
determining, by the controller, the driving lane of the host vehicle based on the location of the host vehicle.

17. The method of claim 16, wherein the determining, by the controller, of whether the reverse-driving vehicle exists in front of the host vehicle on the driving lane of the host vehicle based on whether the lane in which the nearby vehicle determined as driving in the reverse direction coincides with the driving lane of the host vehicle includes calculating an absolute location of the nearby vehicle determined as driving in the reverse direction based on a relative location of the nearby vehicle determined as driving in the reverse direction to the location of the host vehicle determined, using the location of the host vehicle and the information on surroundings.

18. The method of claim 17, wherein the determining, by the controller, of whether the reverse-driving vehicle exists in front of the host vehicle on the driving lane of the host vehicle based on whether the lane in which the nearby vehicle determined as driving in the reverse direction coincides with the driving lane of the host vehicle includes:
calculating, by the controller, an N-axis distance to the nearby vehicle determined as driving in the reverse direction with respect to a center line of the driving lane of the host vehicle on the SN coordinate system based on the absolute location of the nearby vehicle determined as driving in the reverse direction, and
determining, by the controller, a lane in which the nearby vehicle determined as driving in the reverse direction is driving, based on the N-axis distance to the nearby vehicle determined as driving in the reverse direction.

19. The method of claim 17, wherein the determining, by the controller, of whether the reverse-driving vehicle exists in front of the host vehicle on the driving lane of the host vehicle based on whether the lane in which the nearby vehicle determined as driving in the reverse direction coincides with the driving lane of the host vehicle includes determining, by the controller, a driving lane of the nearby vehicle determined as driving in the reverse direction in consideration of at least one of a width of the lane in which the nearby vehicle is driving or a width of the nearby vehicle determined as driving in the reverse direction.

20. The method of claim 12, further comprising:
outputting, by an output device, a request for transfer of control authority when the controller determines that the transfer of control authority to the user is required, the output device being disposed in the host vehicle.
